(19) United States
(12) Patent Application Publication
(10) Pub. No.: US 2008/0209143 A1
(43) Pub. Date: Aug. 28, 2008

(54) DIGITAL MULTI-FUNCTION PERIPHERAL AND CONTROL METHOD FOR THE SAME

(75) Inventor: Toshiharu Takahashi, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/679,006

(22) Filed: Feb. 26, 2007

(51) Int. Cl. G06F 12/16

(52) U.S. Cl. 711/162

(57) ABSTRACT

A digital multi-function peripheral includes a multi-function peripheral unit having a plurality of functions, and a memory module detachably connected to the multi-function peripheral unit. The memory module stores a control program for backup and restore to be executed by the multi-function peripheral unit in a state where the memory module is connected to the multi-function peripheral unit, and the control program selects various default information set in the multi-function peripheral unit as a combination information group suitable for an object resource of default setting, and causes the multi-function peripheral unit to perform a backup to the memory module and a restore from the memory module.

### BACKGROUND OF THE INVENTION

1. Field of the Invention

The present invention relates to a digital multi-function peripheral in which default setting is generally performed in advance and a control method for the same.

2. Description of the Related Art

At the present time, many business offices introduce digital multi-function peripherals to create printed matters necessary for the business. The digital multi-function peripheral has generally a plurality of functions such as an image read function, an image print function, and an image copy function. In the case where the digital multi-function peripheral is additionally installed, a service man previously performs default setting, which serves for customization of these functions. In this default setting, for example, user data, such as an address book, created by the end user of the digital multi-function peripheral for the business of the business office, setting data to specify at least a function option of the digital multi-function peripheral, SRAM data to define a setup environment including a hardware configuration of the digital multi-function peripheral and basic parameters, and the like are set for the digital multi-function peripheral as the default information. However, since the number of detailed items of the default information increases as the function becomes more advanced, it is difficult to finish the maintenance service work in a short time.

Thus, in general, as shown in FIG. 33, the service man performs the default setting by transferring default information from an already installed digital multi-function peripheral to a digital multi-function peripheral for additional installation. Specifically, a portable computer is connected to the already installed digital multi-function peripheral through a serial cable in order to read the default information, and is connected to the multi-function peripheral for additional installation through this serial cable in order to write the default information. In the case where a network such as a LAN is provided in the business office as the network environment for the digital multi-function peripheral, the portable computer is connected to the already installed digital multi-function peripheral and the digital multi-function peripheral for additional installation through this network in order to read and write the default information.

The default setting is performed not only in the case where the digital multi-function peripheral is additionally installed, but also in the case where an option member, such as a FAX kit, is added to the already installed digital multi-function peripheral. Further, as shown in FIG. 34, it is also performed in the case where an old system board provided in the already installed digital multi-function peripheral is replaced with a new type, or in the case where a hard disk drive is replaced due to a failure.

In any case, it is necessary for the service man to carry the portable computer and the serial cable for the default setting. Although the serial cable is unnecessary for the business office in which the network environment exists, when the network environment is borrowed for the default setting, there is a fear that default information to be concealed, such as an address book, is leaked. Although it is also possible to temporarily construct a network environment, this requires work to establish the network connection. Besides, in the case where the communication speed between the portable computer and the digital multi-function peripheral is not high, this causes the work time of the maintenance service (default setting) to increase.

The default information to be actually transferred depends on an object resource (model or part) of default setting. That is, in the case where the object resource of the default setting is the same model, all of the default information acquired from the already installed digital multi-function peripheral can be applied to the digital multi-function peripheral for additional installation. On the other hand, in the case where the object resource of the default setting is a different model, only a part of the default information acquired from the already installed digital multi-function peripheral can be applied to the digital multi-function peripheral for additional installation. Besides, in the case where the object resource of the default setting is a hard disk provided for storing user data, default information other than the user data is not required in the replacement of the failed hard disk drive.

Hitherto, there is known a technique in which in view of convenience and safety, personal setting information is stored in a flash memory card, and this setting information is temporarily used instead of default information previously set in a shared image input and output equipment (see, for example, JP-A-2000-326592). Although this image input and output equipment can update the setting information stored in the flash memory card, this can not facilitate the maintenance service work varying according to the object resource of the default setting.

### BRIEF SUMMARY OF THE INVENTION

It is an object of the invention to provide a digital multi-function peripheral in which maintenance service work can be facilitated irrespective of an object resource of default setting and a control method for the same.

According to a first aspect of the invention, a digital multi-function peripheral includes a multi-function peripheral unit having a plurality of functions, and a memory module detachably connected to the multi-function peripheral unit, the memory module stores a control program for backup and restore to be executed by the multi-function peripheral unit in a state where the memory module is connected to the multi-function peripheral unit, the control program selects various default information set in the multi-function peripheral unit as a combination information group suitable for an object resource of default setting and causes the multi-function peripheral unit to perform a backup to the memory module and a restore from the memory module.

According to a second aspect of the invention, a control method for a digital multi-function peripheral including a multi-function peripheral unit having a plurality of functions and a memory module detachably connected to the multi-function peripheral unit, includes storing a control program for backup and restore into the memory module, selecting various default information set in the multi-function peripheral unit as a combination information group suitable for an object resource of default setting by causing the multi-function peripheral unit to perform the control program in a state where the memory module is connected to the multi-function peripheral unit, and causing the multi-function peripheral unit to perform a backup to the memory module and a restore from the memory module.

In the digital multi-function peripheral and the control method for the same, the multi-function peripheral unit executes the control program stored in the memory module in the state where it is connected to the multi-function peripheral unit, the various default information set in the multi-function peripheral unit is selected as the combination information group suitable for the object resource of the default setting, and the multi-function peripheral unit is made to perform the backup to the memory module and the restore from the memory module. Although the memory module is provided for the multi-function peripheral unit, since it can be detached from this multi-function peripheral unit, it can also be used for the restore of the default information for another digital multi-function peripheral. It is unnecessary for the service man to carry the portable computer and the serial cable for the maintenance service work, such as default setting, or to borrow the network environment on the user side. Besides, in the default setting, the substantial influence of communication speed between the portable computer and the digital multi-function peripheral can be removed. Further, there is no fear that default information to be concealed, such as an address book, is leaked.

Besides, since the backup and the restore can be performed with respect to all default information except the default information unsuitable for the object resource (model or part) of the default setting, the detailed items of the default information which must be set by the service man can be reduced. Accordingly, irrespectively of the object resource of the default setting, the maintenance service work can be facilitated. As a result, a time required for the maintenance service work can be shortened.

Further, since the control program is stored in the memory module detachable from the multi-function peripheral unit, also in the case where the content of the maintenance service work is changed, it can be easily dealt with. In the case where the control program is stored in the multi-function peripheral unit, it becomes necessary to design the multi-function peripheral unit in accordance with specifications including the rewriting function of the control program.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a circuit structure of a digital multi-function peripheral of an embodiment of the invention;

FIG. 2 is a view showing a backup processing in which default information is transferred from a multi-function peripheral unit to a USB memory module shown in FIG. 1;

FIG. 3 is a view showing a restore processing in which default information is transferred from the USB memory module shown in FIG. 1 to the multi-function peripheral unit;

FIG. 4 is a view showing combinations of the default information selected for the backup processing shown in FIG. 2 and for the restore processing shown in FIG. 3 for the respective object resources of default setting;

FIG. 5 is a flowchart showing operations controlled by a backup-restore control program shown in FIG. 2 and FIG. 3;

FIG. 6 is a view showing a message displayed during download of the backup-restore control program shown in FIG. 2 and FIG. 3;

FIG. 7 is a view showing a default information menu displayed subsequently to the message shown in FIG. 6;

FIG. 8 is a view showing a message displayed immediately after item selection performed while the default information menu shown in FIG. 7 is confirmed;

FIG. 9 is a view showing a user data backup menu displayed subsequently to the message shown in FIG. 8;

FIG. 10 is a view showing a progress situation displayed during user data backup started by selecting items 4 to 6 of the menu shown in FIG. 9;

FIG. 11 is a view showing a progress situation in which the state shown in FIG. 10 has been changed to a state of notifying the completion of the user data backup;

FIG. 12 is a view showing a setting data backup menu displayed subsequently to the message shown in FIG. 8;

FIG. 13 is a view showing a progress situation displayed during setting data backup started by selecting items 1 to 6 of the menu shown in FIG. 12;

FIG. 14 is a view showing a progress situation in which the state shown in FIG. 13 has been changed to a state of notifying the completion of the setting data backup;

FIG. 15 is a view showing an SRAM data backup menu displayed subsequently to the message shown in FIG. 8;

FIG. 16 is a view showing a progress situation displayed during SRAM data backup started by selecting item 1 of the menu shown in FIG. 15;

FIG. 17 is a view showing a progress situation in which the state shown in FIG. 16 has been changed to a state of notifying the completion of the SRAM data backup;

FIG. 18 is a view showing a user data restore menu displayed subsequently to the message shown in FIG. 8;

FIG. 19 is a view showing a progress situation displayed during user data restore started by selecting items 4 to 6 of the menu shown in FIG. 18;

FIG. 20 is a view showing a progress situation in which the state shown in FIG. 19 has been changed to a state of notifying the completion of the user data restore;

FIG. 21 is a view showing a setting data restore menu displayed subsequently to the message shown in FIG. 8;

FIG. 22 is a view showing a progress situation displayed during setting data restore started by selecting items 1 to 6 of the menu shown in FIG. 21;

FIG. 23 is a view showing a progress situation in which the state shown in FIG. 22 has been changed to a state of notifying the completion of the setting data restore;

FIG. 24 is a view showing an SRAM data restore menu displayed subsequently to the message shown in FIG. 8;

FIG. 25 is a view showing a progress situation displayed during SRAM data restore started by selecting item 1 of the menu shown in FIG. 24;

FIG. 26 is a view showing a progress situation in which the state shown in FIG. 25 has been changed to a state of notifying the completion of the SRAM data restore;

FIG. 27 is a view showing a message to notify an error occurring with respect to the backup of item 4 of the user data backup menu shown in FIG. 9;

FIG. 28 is a view showing error codes displayed as an error X shown in FIG. 27 and error contents corresponding to the error codes;

FIG. 29 is a view showing an example of backup performed while the default information shown in FIG. 2 is encoded into an encoded data file;

FIG. 30 is a view showing an example of restore performed while the encoded data file shown in FIG. 3 is decoded into the default information;

FIG. 31 is a view showing encoded files of user data, setting data and SRAM data stored in the USB memory module shown in FIG. 1;

FIG. 32 is a view showing a basic format of an index file stored in the USB memory module shown in FIG. 1 together with the encoded files of the user data, the setting data and the SRAM data;

FIG. 33 is a view showing transfer of default information performed in the case where an object resource of default setting is a digital multi-function peripheral for additional installation; and

FIG. 34 is a view showing transfer of default information performed in the case where an object resource of default setting is a system board in an already installed digital multi-function peripheral.

### DETAILED DESCRIPTION OF THE INVENTION

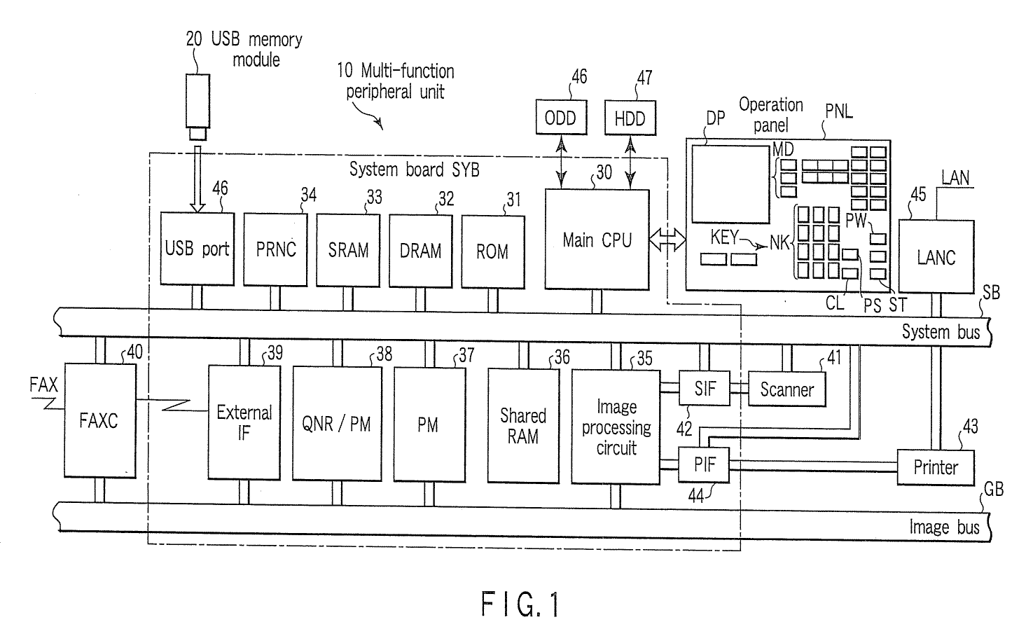

Hereinafter, a digital multi-function peripheral of an embodiment of the invention will be described with reference to the accompanying drawings. FIG. 1 shows a circuit structure of this digital multi-function peripheral. The digital multi-function peripheral includes a multi-function peripheral unit 10 having a plurality of functions such as, for example, an image read function, an image print function, an image copy function and a facsimile communication function added as an option, and a USB memory module 20 detachably connected to the multi-function peripheral unit 10. The multi-function peripheral unit 10 includes a system board SYB and peripheral circuits connected to this system board SYB.

The system board SYB includes a main CPU 30, a ROM 31, a DRAM 32, an SRAM 33 and a control circuit (PRNC) 60. The main CPU 30 controls the whole of the multi-function peripheral unit 10 having the plurality of functions. The ROM 31 stores a main control program of the main CPU 30 and fixed data required to realize the foregoing functions in the multi-function peripheral unit 10. The DRAM 32 temporarily stores various data inputted to and outputted from the main CPU 30. The SRAM 33 stores, as SRAM data, data defining a setup environment including the hardware configuration of the digital multi-function peripheral and basic parameters. The control circuit 60 performs protocol control to receive print data from an apparatus such as an external computer, and data transfer, compression and expansion control. The system board SYB further includes an image processing circuit 35, a shared RAM 36, a page memory (PM) 37, a quantization page memory (QNR/PM) 38, and an external interface (external IF) 39. The image processing circuit 35 performs, as an image processing, image edition such as improvement in picture quality suitable for a recording medium, enlargement, contraction, thinning of pixels, and formation of an outlined specified area by marker detection. The shared RAM 36 stores data to which a plurality of digital multi-function peripherals can refer. The page memory 37 stores image data of a plurality of pages in which each pixel is represented in a multi-valued form of multi-bit. The quantization page memory 38 includes an image processing ASIC to process image data for recording and reproduction, a compression and expansion circuit to compress pixel data from a multi-valued form to a binary form and to expand pixel data from the binary form to the multi-valued form, and a binary page memory (page buffer) to store the image data of the binary form. The external interface 39 is an interface to connect an external circuit, such as a facsimile kit (FAXC) 40 or a wireless LAN/Bluetooth kit, which is added as an option.

The image processing circuit 35 is connected with a scanner 41 through a scanner interface (SIF) 42, and is further connected with a printer 43 through a printer interface (PIF) 44. The scanner interface (SIF) 42 inputs image data obtained from the scanner 41 to the image processing circuit 35, and the printer interface 44 outputs image data obtained from the image processing circuit 35 to the printer 43.

The main CPU 30 is connected to the main CPU 30, the ROM 31, the DRAM 32, the SRAM 33, the image processing circuit 35, the shared RAM 36, the page memory 37, the quantization page memory 38, the external interface 39, the facsimile kit 40, the scanner 41, the scanner interface 42, the printer 43 and the printer interface 44 through a system bus SB for control. The image processing circuit 35, the page memory 37, the quantization page memory 38, the external interface 39 and the facsimile kit 40 are provided as a processing board to be mounted to the system board SYB, and are mutually connected to each other through an image bus GB for image data. The image bus GB is provided in order to ensure the real-time property of the copying function by performing, in parallel, an operation of the scanner interface 42 to capture image data from the scanner 41, an operation of the image processing circuit 35 to perform an image processing on the image data from the scanner interface 42, and an operation of the printer interface 44 to output the image data processed by the image processing circuit 35 to the printer 43. Each of the processing boards is brought into a state in which the image data on the image bus GB passes in a period when execution of a processing is not required in a specific operation. For example, since the quantization page memory 38 does not require the execution of a processing at the time of a simple copy operation, it is brought into the state in which the image data passes. However, in the case where the edition of a plurality of copy images is required in this copy operation, the image data is stored in the quantization page memory 38.

Besides, the system bus SB is connected with a network control circuit (LANC) 45 for LAN and a USB port 46. The network control circuit 45 is connected through a cable to a LAN control equipment, such as a router or a repeater, provided in the outside, and communicates with another digital multi-function peripheral or a computer controlled by the LAN control equipment on the LAN. The USB port 46 enables access to a memory area in the USB memory module 20 in accordance with the connection of the USB memory module 20.

Further, the multi-function peripheral unit 10 includes an operation panel PNL connected to the main CPU 30, a hard disk drive (HDD) 47 and an optical disk drive (ODD) 48. The operation panel PNL is a user interface to the main CPU 30, and includes a touch panel display DP and a hardware key KEY. The hardware key KEY includes a power source key PW, a start key ST, a pause key PS, a clear key CL, a numeric key NK, a mode selection key MD and the like. The hard disk drive 47 and the optical disk drive 48 are used for mainly storing large-capacity data such as image data. Besides, a working folder is provided in the hard disk drive 47.

Various default data include user data created by the end user of the digital multi-function peripheral for the business of the business establishment, setting data to specify at least a function option of the digital multi-function peripheral, and SRAM data to define the setup environment including the hardware configuration of the digital multi-function peripheral and basic parameters. The user data includes, for example, an address book, a mail box, a template, a department code, a user list and the like, and is stored in the hard disk drive 47. The setting data includes, for example, top access-setup data for network and print service prepared as setting items for a person in charge of maintenance and self diagnosis setting items for an option equipment, top access-setup data for save to a shared memory folder, E mail, and Internet access, top access-maintenance data for notification setting, top access-maintenance data for directory service (LDAP), code data for setting a FAX kit as an option, and code data for setting a wireless LAN and Bluetooth kit as an option, and is stored in the relevant components such as the scanner 41, the printer 43, the facsimile kit 40, and the network control circuit 45. The SRAM data is stored in the SRAM 33.

The USB memory module 20 previously stores a backup-restore control program to various default information set in the multi-function peripheral unit 10. The backup-restore control program is executed by the main CPU 30 of the multi-function peripheral unit 10 in the state where the USB memory module 20 is connected to the USB port 46 of the multi-function peripheral unit 10, and structured to select various default information as a combination information group suitable for the object resource (model or part) of the default setting, and to cause the multi-function peripheral unit 10 to perform a backup to the memory module 20 and a restore from the memory module 20.

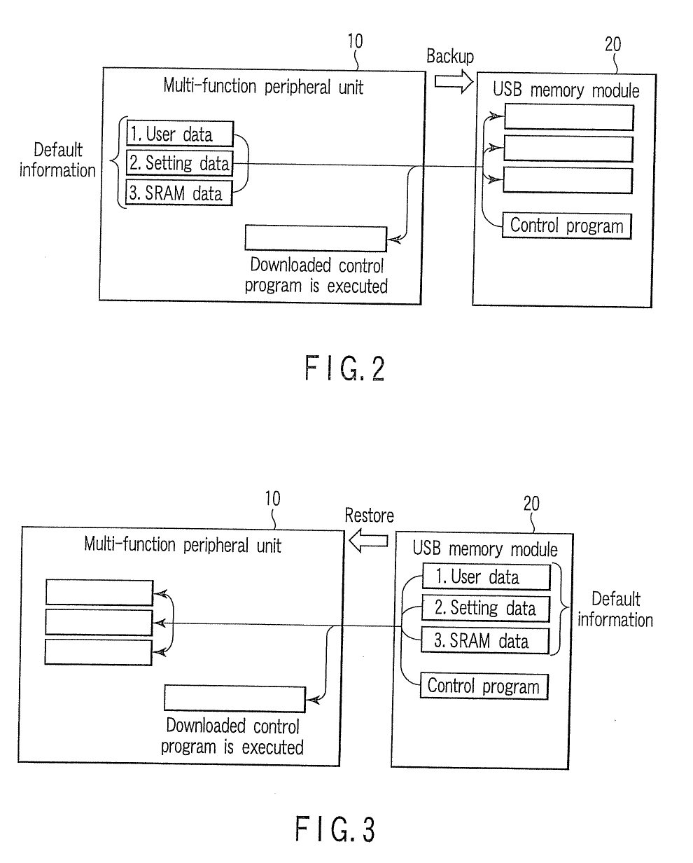

FIG. 2 shows a backup processing in which the default information is transferred from the multi-function peripheral unit 10 to the USB memory module 20, and FIG. 3 shows a restore processing in which the default information is transferred from the USB memory module 20 to the multi-function peripheral unit 10. When the USB memory module 20 is connected to the USB port 46, the main CPU 30 can access the memory area in the USB memory module 20, and downloads the backup-restore control program called “USB maintenance module” stored in the USB memory module 20 into the DRAM 32 and executes it.

In the case where the backup processing is performed in accordance with this backup-restore control program, the user data, the setting data and the SRAM data are selectively read from the multi-function peripheral unit 10 as shown in FIG. 2, and are stored in the memory area of the USB memory module 20. On the other hand, in the case where the restore processing is performed in accordance with this backup-restore control program, the user data, the setting data and the SRAM data are selectively read from the memory area of the USB memory module 20 as shown in FIG. 3, and are stored in the relevant components of the multi-function peripheral unit 10.

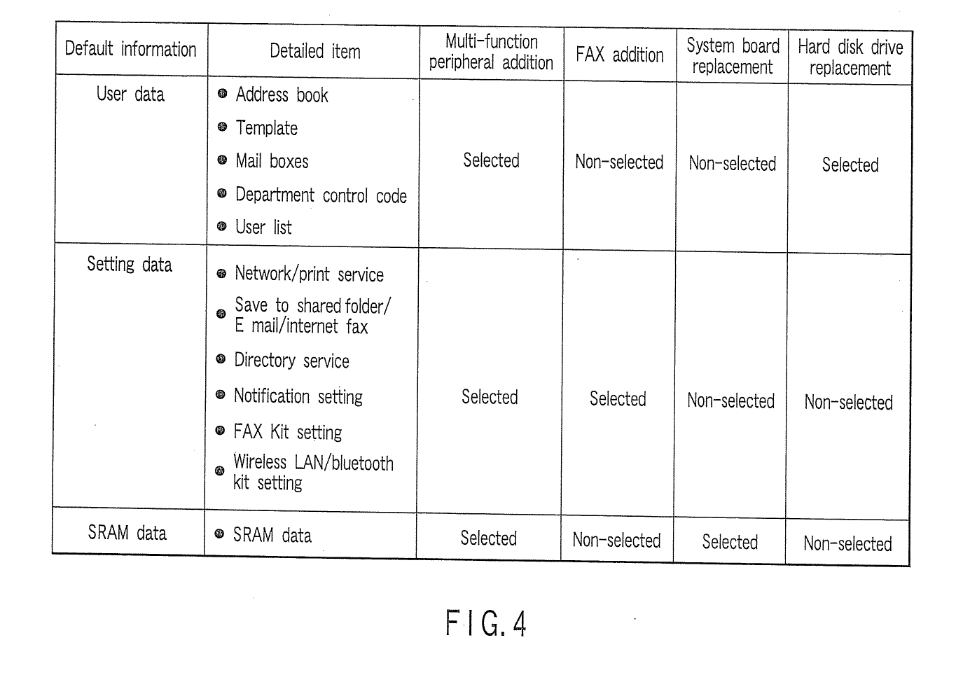

FIG. 4 shows the default information selected for the backup processing and the restore processing, that is, the combination of the user data, the setting data and the SRAM data for the respective object resources of the default setting. For example, in the default setting for additionally installing a multi-function peripheral, all of the user data, the setting data and the SRAM data are selected. In the case where the facsimile kit 40 is added, only the setting data is selected. In the case where the system board SYB is replaced, only the SRAM data is selected. Further, in the case where the hard disk drive 47 is replaced, only the user data is selected.

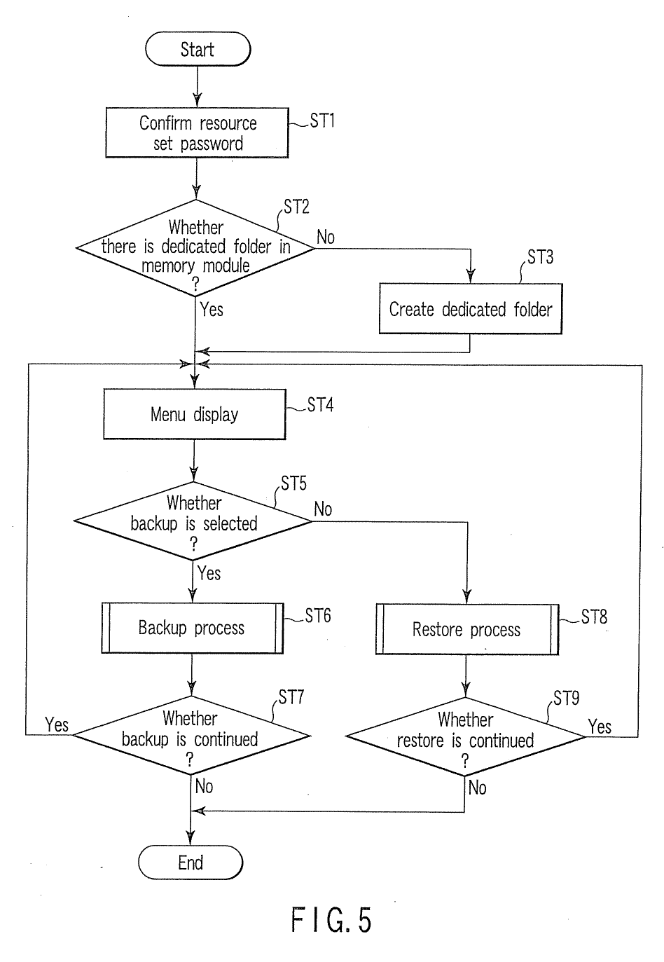

As shown in FIG. 5, when the control by the backup-restore control program is started, resource confirmation and password setting are performed at step ST1. The resource confirmation is performed by checking the model number of the multi-function peripheral unit 10, the ROM version (specifically, the main control program version in the ROM 31) and the like, and the password setting requires password input from the operation panel PNL, and is performed by storing the password inputted in response to this request into the working folder. The inputted password is stored in the USB memory module 20 at the backup, and is checked with the password in the USB memory module 20 at the restore. At subsequent step ST2, it is checked whether a dedicated folder to store the default information exists in the USB memory module 20. If not, the dedicated folder is created at step ST3 in the USB memory module 20.

Thereafter, a default information menu is displayed on the operation panel PNL at step ST4, and it is checked at step ST5 whether the backup has been selected in this default information menu. When the backup is selected, a backup processing is performed at step ST6. After the backup processing, it is checked at step ST7 whether the backup is continued. In the case where the backup is continued, the step ST4 is again executed. Besides, in the case where the backup is not continued, the control by the backup-restore control program is ended.

On the other hand, when the restore is selected at the step ST5, a restore processing is performed at step ST8. After the restore processing, it is checked at step ST9 whether the restore is continued. In the case where the restore is continued, the step ST4 is again executed. Besides, in the case where the restore is not continued, the control by the backup-restore control program is ended.

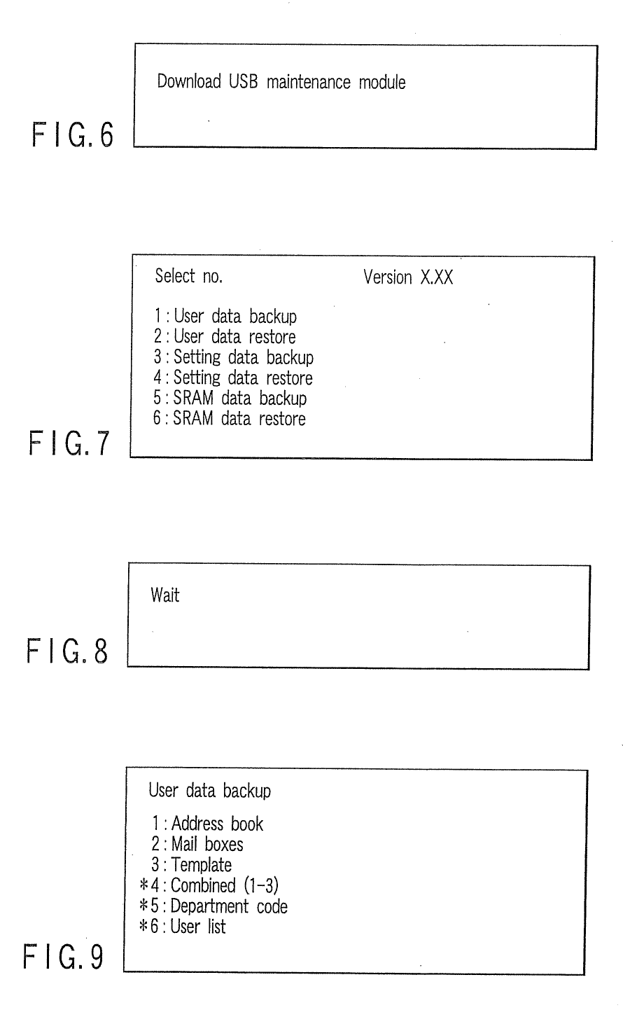

Hereinafter, display contents of the touch panel display DP on the operation panel PNL will be described. When the USB memory module 20 is connected to the USB port 46, as shown in FIG. 6, a message indicating that the “USB maintenance module” is being downloaded is displayed. After this download, at the step ST4 shown in FIG. 5, a default information menu is displayed as shown in FIG. 7. In this default information menu, an item selection request message is displayed together with menu selection items 1 to 6 and version X.XX of the main control program. The items 1 to 6 are “user data backup”, “user data restore”, “setting data backup”, “setting data restore”, “SRAM data backup” and “SRAM data restore”, respectively.

The backup of the default information is performed as described below. For example, the “user data backup” of the item 1 is selected by the operation of the numeric key NK, and when this selection is decided by the operation of the start key ST, the message of “wait” shown in FIG. 8 is temporarily displayed. During this, it is confirmed that the selection result is the backup, and the backup processing of the step ST6 shown in FIG. 5 is performed. When this backup processing is started, a user data backup menu shown in FIG. 9 is first displayed. In this user data backup menu, the title “user data backup” and menu selection items 1 to 6 are displayed. The items 1 to 6 are “address book”, “mail boxes”, “template”, “combined (1-3)”, “department code” and “user list”, respectively. The “combined (1-3)” of the item 4 is the item for selecting the “address book” of the item 1, the “mail boxes” of the item 2, and the “template” of the item 3 together. An asterisk indicates a selected item. Here, the item 4, the item 5 and the item 6 are selected by default. The default selection can be cancelled and changed in toggle-model fashion by the operation of the numeric key NK corresponding to the item number. The selected item is decided by the operation of the start key ST. For example, when the start key ST is operated in the state where the items 4 to 6 are selected, the backup of these items is started, and a progress situation shown in FIG. 10 is displayed during the user data backup. When the backup of the final item 6 is completed, the progress situation is changed into a state of notifying the completion of the user data backup as shown in FIG. 11. When the power source key PW is operated in this state, it is confirmed that the backup is not continued at the step ST9 shown in FIG. 5, and the access to the USB memory module 20 is ended (when the power source key PW is pressed long, since the power source of the multi-function peripheral is turned off, here, the power source key PW is one-touch operated). On the other hand, when the start key ST is operated, since the continuation of the backup is confirmed, the default information menu shown in FIG. 7 is again displayed.

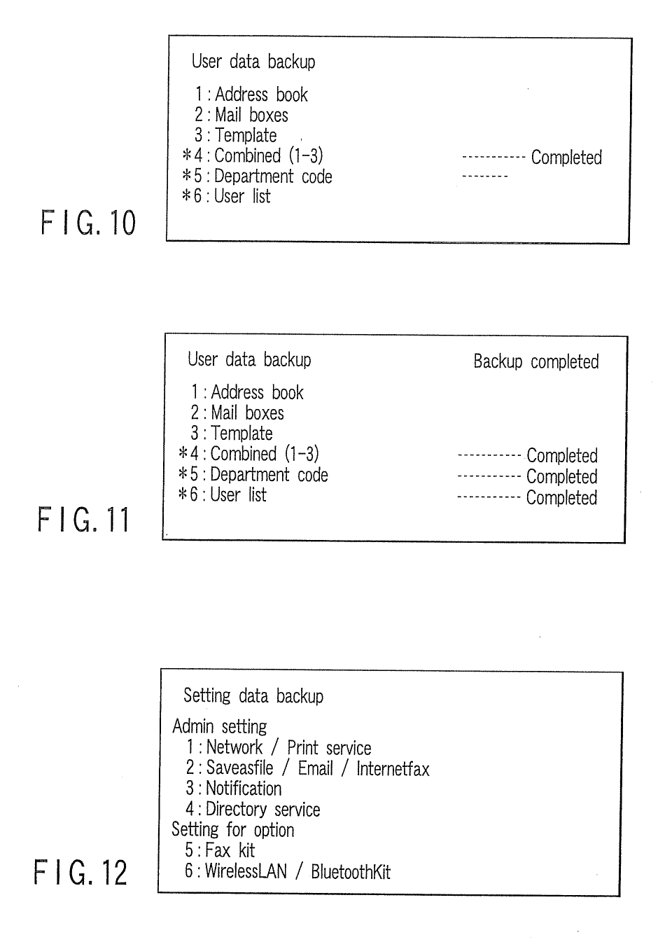

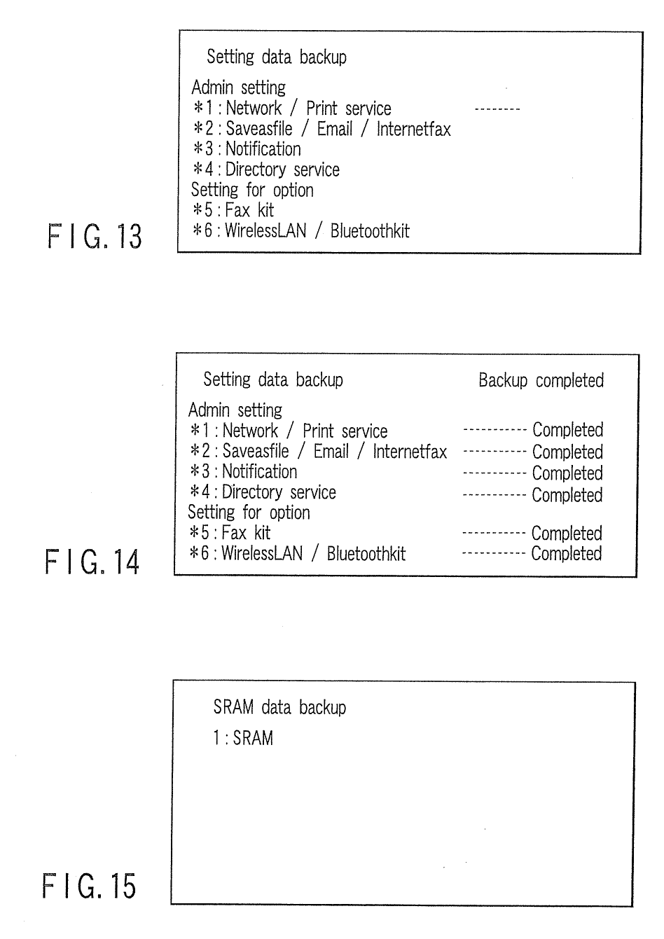

Reference is made to the default information menu, the “setting data backup” of the item 3 is selected by the operation of the numeric key NK, and when this selection is decided by the operation of the start key ST, the message of “wait” shown in FIG. 8 is temporarily displayed. During this, it is confirmed that the selection result is the backup, and the backup processing of the step ST6 shown in FIG. 5 is performed. When this backup processing is started, a setting data backup menu shown in FIG. 12 is first displayed. In this setting data backup menu, the title “setting data backup” and menu selection items 1 to 6 are displayed. The items 1 to 4 are “network and print service”, “save to shared memory folder, E mail, Internet access”, “notification setting” and “directory service (LDAP)” and are setting data classified into the top access setting items for the person in charge of maintenance, and the items 5 and 6 “FAX kit” and “wireless LAN and Bluetooth kit” and are setting data classified into the self diagnosis setting items for option equipments. These items 1 to 6 are not selected by default, but are selected by the operation of the numeric key NK corresponding to the item number. The selected item is decided by the operation of the start key ST similarly to the “user data backup”. For example, when the start key ST is operated in a state where all the items 1 to 6 are selected, the backup of these items is started, and a progress situation shown in FIG. 13 is displayed during the setting data backup. When the backup of the final item 6 is completed, the progress situation is changed to a state of notifying the completion of the setting data backup as shown in FIG. 14. Thereafter, the power supply key PW or the start key ST is operated, and it is specified whether the backup is continued similarly to the “user data backup”.

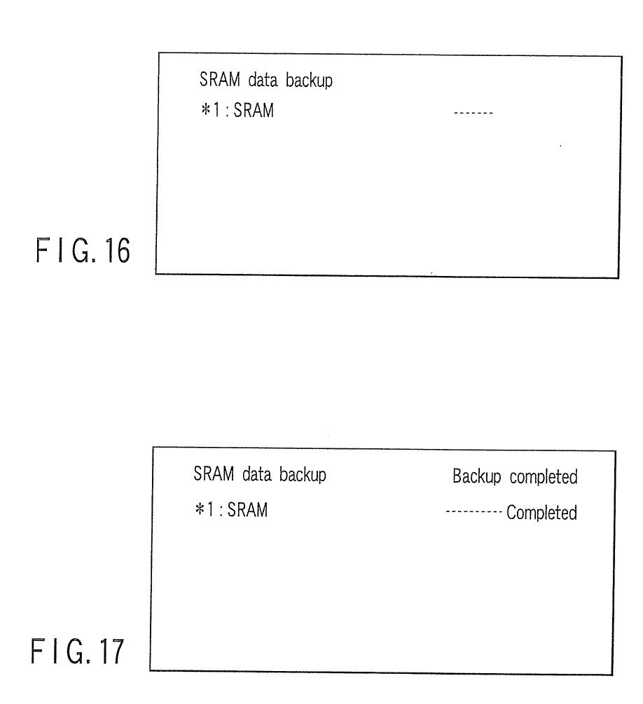

Reference is made to the default information menu, the “SRAM data backup” of the item 5 is selected by the operation of the numeric key NK, and when this selection is decided by the operation of the start key ST, the message of “wait” shown in FIG. 8 is temporarily displayed. During this, it is confirmed that the selection result is the backup, and the backup processing of the step ST6 shown in FIG. 5 is performed. When this backup processing is started, an SRAM data backup menu shown in FIG. 15 is first displayed. In this SRAM data backup menu, the title “SRAM data backup” and menu selection item 1 is displayed. The item 1 is the SRAM data and is selected by default. When this selected item is decided by the operation of the start key ST similarly to the user data backup, the backup of the SRAM data is started, and a progress situation shown in FIG. 16 is displayed during the SRAM data backup. When the backup of the item 1 is completed, the progress situation is changed to a state of notifying the completion of the SRAM data backup as shown in FIG. 17. Thereafter, the power source key PW or the start key ST is operated, and it is specified whether the backup is continued similarly to the “user data backup”.

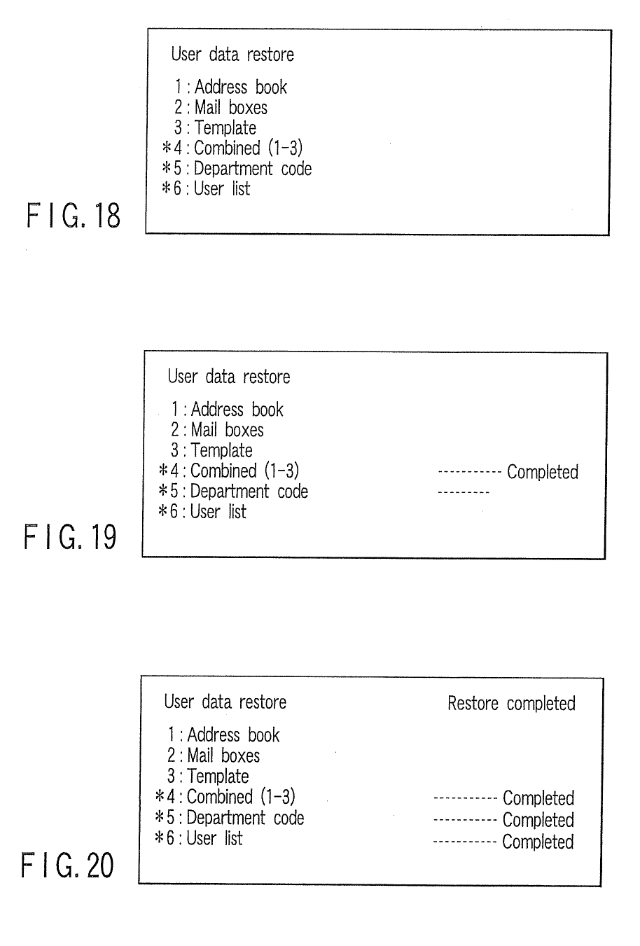

The restore of the default information is performed as described below. For example, the “user data restore” of the item 2 is selected by the operation of the numeric key NK, and when this selection is decided by the operation of the start key ST, the message of “wait” shown in FIG. 8 is temporarily displayed. During this, it is confirmed that the selection result is the restore, and the restore processing of the step ST8 shown in FIG. 5 is performed. When this restore processing is started, a user data restore menu shown in FIG. 18 is first displayed. In this user data restore menu, the title “user data restore” and menu selection items 1 to 6 are displayed. The items 1 to 6 are “address book”, “mail boxes”, “template”, “combined (1-3)”, “department code” and “user list”. The “combined (1-3)” of the item 4 is the item for selecting the “address book” of the item 1, the “mail boxes” of the item 2 and the “template” of the item 3 together. An asterisk denotes a selected item. Here, the item 4, the item 5 and the item 6 are selected by default. The default selection can be cancelled and changed in toggle-model fashion by the operation of the numeric key NK corresponding to the item number. The selected key is decided by the operation of the start key ST. For example, when the start key ST is operated in the state where the items 4 to 6 are selected, the restore of these items is started, and a progress situation shown in FIG. 19 is displayed during the user data restore. When the restore of the final item 6 is completed, the progress situation is changed to a state of notifying the completion of the user data restore as shown in FIG. 20. When the power source key PW is operated in this state, it is confirmed at step ST13 shown in FIG. 5 that the restore is not continued, and the access to the USB memory module 20 is ended (the power source key PW is one-touch operated similarly to the time of backup). On the other hand, the start key ST is operated, since the continuation of the restore is confirmed, the default information menu shown in FIG. 7 is again displayed.

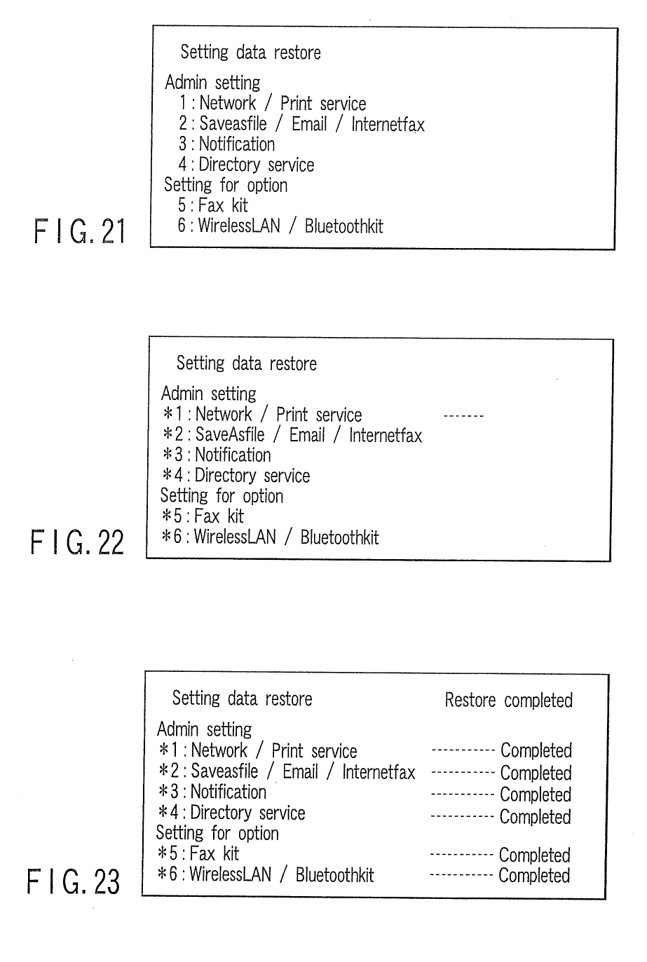

Reference is made to the default information menu, the “setting data restore” of the item 4 is selected by the operation of the numeric key NK, and when this selection is decided by the operation of the start key ST, the message of “wait” shown in FIG. 8 is temporarily displayed. During this, it is confirmed that the selection result is the restore, and the restore processing of the step ST8 shown in FIG. 5 is performed. When this restore processing is started, a setting data restore menu shown in FIG. 21 is first displayed. In this setting data restore menu, the title “setting data restore” and menu selection items 1 to 6 are displayed. The items 1 to 4 are “network and print service”, “save to shared memory folder, E mail, Internet access”, “notification setting” and “directory service (LDAP) and are the setting data classified into the top access setting items for the person in charge of maintenance, and the items 5 and 6 are “FAX kit” and “wireless LAN and Bluetooth kit” and are the setting data classified into the self diagnosis setting items for option equipments. These items 1 to 6 are not selected by default, but are selected by the operation of the numeric key NK corresponding to the item number. The selected item is decided by the operation of the start key ST similarly to the “user data restore”. For example, when the start key ST is operated in the state where all the items 1 to 6 are selected, the restore of these items is started, and a progress situation shown in FIG. 22 is displayed during the setting data restore. When the restore of the final item 6 is completed, the progress situation is changed to a state of notifying the completion of the setting data restore as shown in FIG. 23. Thereafter, the power source key PW or the start key ST is operated, and it is specified whether the restore is continued similarly to the “user data restore”.

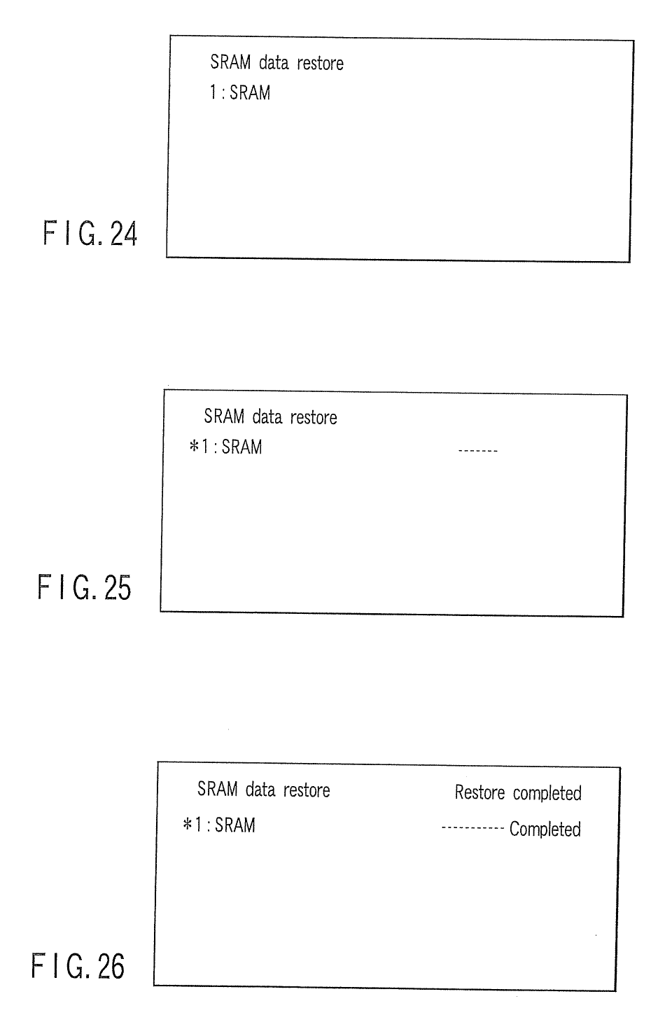

Reference is made to the default information menu, the “SRAM data restore” of the item 6 is selected by the operation of the numeric key NK, and when this selection is decided by the operation of the start key ST, the message of “wait” shown in FIG. 8 is temporarily displayed. During thus, it is confirmed that the selection result is restore, and the restore processing of the step ST8 shown in FIG. 5 is performed. When this restore processing is started, an SRAM restore menu shown in FIG. 24 is first displayed. In this SRAM data restore menu, the title “SRAM data restore” and menu selection item 1 is displayed. The item 1 is the SRAM data and is selected by default. When this selected item is decided by the operation of the start key ST similarly to the user data restore, the restore of the SRAM data is started, and a progress situation shown in FIG. 25 is displayed during the SRAM data restore. When the restore of the item 1 is completed, the progress situation is changed to a state of notifying the completion of the SRAM data restore as shown in FIG. 26. Thereafter, the power source key PW or the start key ST is operated, and it is specified whether the restore is continued similarly to the “user data restore”.

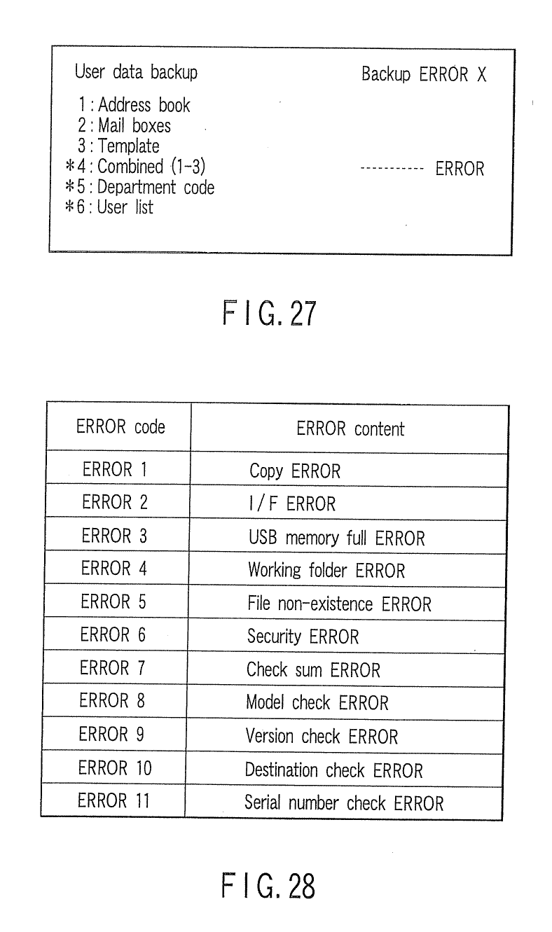

While the backup processing and the restore processing are performed at the step ST6 and the step ST8 shown in FIG. 5, various errors are checked. For example, when an error occurs with respect to the backup of the item 4 of the user data backup menu, a message notifying this error is displayed as shown in FIG. 27. In this message, an error code is added as an error X (here, X=1 to 11) shown in FIG. 27. The contents of these errors 1 to 11 are shown in FIG. 28. That is, error 1 is a copy error in which the copy of the default information is incomplete. Error 2 indicates an interface error in the USB port 46. Error 3 indicates a USB memory full error in which the free space of the USB memory module 20 becomes insufficient. Error 4 indicates a working folder error due to a working folder temporarily created for the backup or the restore of the default information. Error 5 indicates a file non-existence error in which the default information to be backed up or restored does not exist as a file. Error 6 indicates a security error in which there is no authority to perform the backup or the restore of the default information. Error 7 indicates a check sum error of a file stored as the default information. Error 8 is a model check error in which the restriction of a model or a part is confirmed with respect to the backup of specific default information. Error 9 is a version check error in which it is confirmed that the version of the backup-restore control program does not conform to the version of the main control program. Error 10 is a destination check error in which the restriction of a model or a part is confirmed with respect to the restore of specific default information. Error 11 is a serial number check error in which it is confirmed that the serial numbers of the multi-function peripherals of the backup source and the restore destination of the default information are inconsistent with each other. With respect to the errors 1 to 10, the backup and the restore of the error-displayed item is omitted. With respect to the error 11, the backup and the restore of the error-displayed item is approved by the operation of the start key ST performed after the display, or is omitted by the operation of the power source key PW performed after the display. That is, as a result of the error check, the backup and the restore are performed while unsuitable detailed items among various default information are removed.

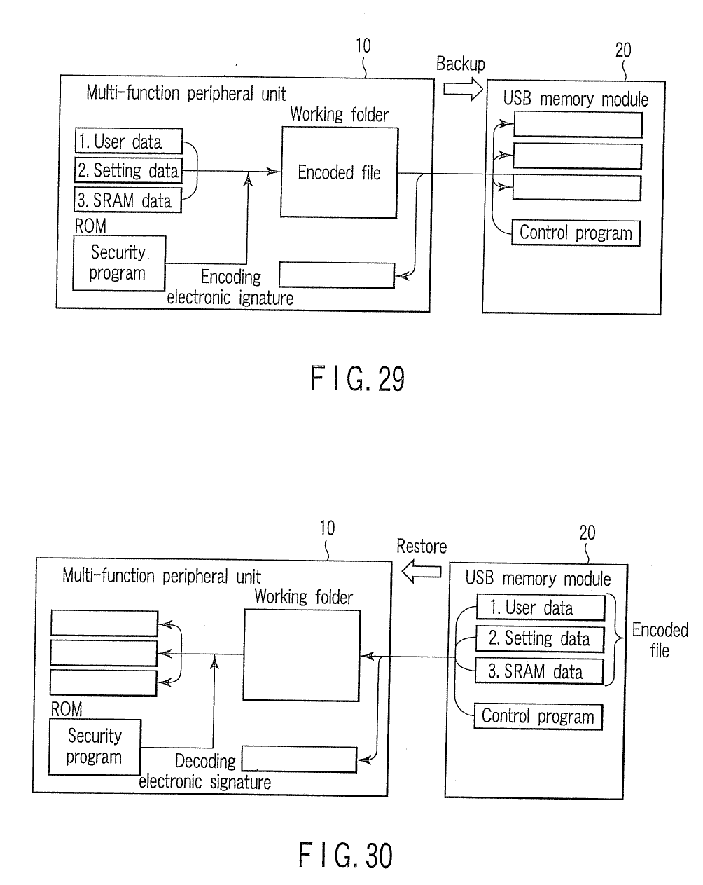

Incidentally, the multi-function peripheral unit 10 may be structured such that the default information is encoded into an encoded data file and is backed up, and this is decoded and is restored. In this case, a security program is installed in the ROM 31 in advance. The security program is called at the time of backup and the time of restore by the backup-restore control program downloaded from the USB memory module 20, and creates an encoding electronic signature and a decoding electronic signature. At the time of backup, as shown in FIG. 29, the default information stored in the multi-function peripheral unit 10, that is, the user data, the setting data and the SRAM data are converted into encoded files by using the encoding electronic signature, and are temporarily stored in the working folder. Thereafter, the encoded files in the working folder are transferred to the USB memory module. Besides, at the time of restore, as shown in FIG. 30, the user data, the setting data and the SRAM data stored as the encoded data files in the USB memory module 20 are transferred to the multi-function peripheral unit 10, and are temporarily stored in the working folder. Thereafter, the encoded files are converted into the user data, the setting data and the SRAM data decoded by using the decoding electronic signature, and are stored in the multi-function peripheral unit 10. In the case where the user data, the setting data and the SRAM data are respectively backed up as the encoded files, index files, together with these encoded files, are backed up in the USB memory module 20.

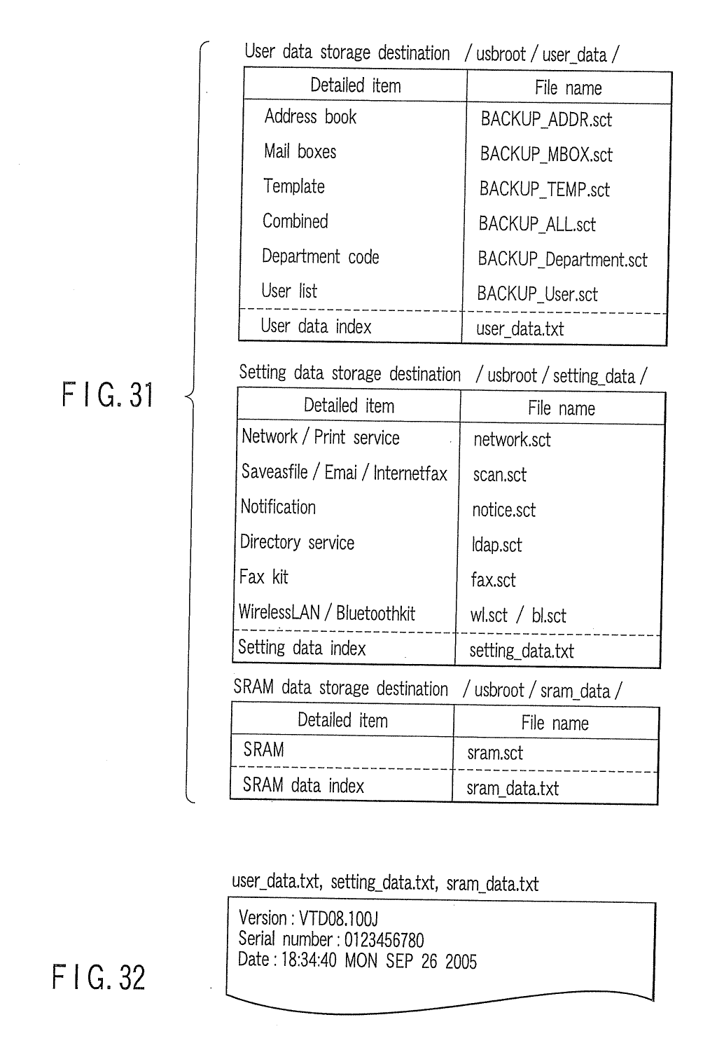

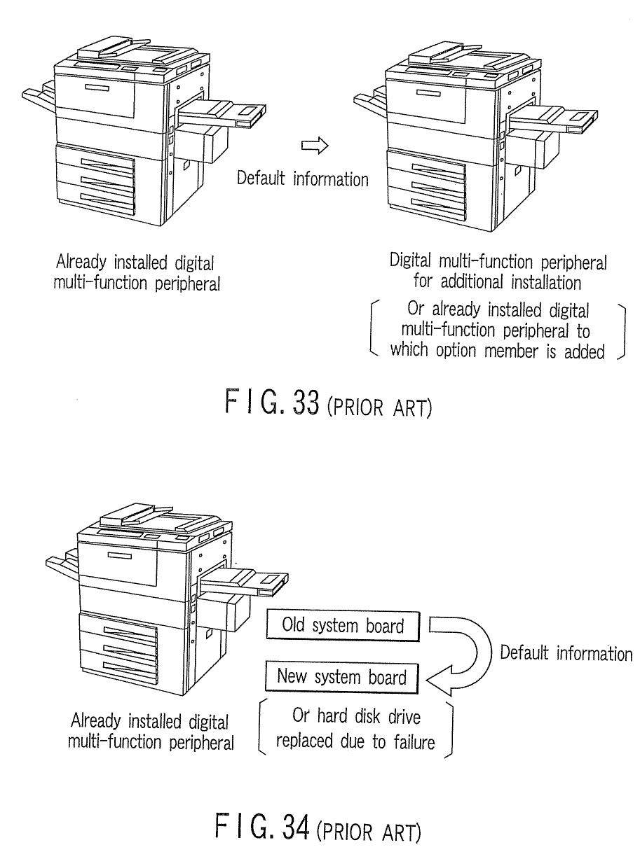

As shown in FIG. 31, the encoded files of the user data, the setting data and the SRAM data with file names corresponding to detailed items are stored into, as storage destinations, dedicated folders provided in the USB memory module 20. Besides, as shown in FIG. 32, each of the index files for the user data, the setting data and the SRAM data is created in a basic format including the version of the main control program, the serial number of the multi-function peripheral and the date of the backup, and is stored in the dedicated folder.

In the digital multi-function peripheral of this embodiment, the multi-function peripheral unit 10 executes the backup-restore control program stored in the USB memory module 20 in the state where it is connected to the multi-function peripheral unit 10, various default information set in the multi-function peripheral unit 10 is selected as the combination information group suitable for the object resource of the default setting, and the multi-function peripheral unit 10 is made to perform the backup to the USB memory module 20 and the restore from the USB memory module 20. Although the USB memory module 20 is provided for the multi-function peripheral unit 10, since it can be detached from this multi-function peripheral unit 10, it can also be used for restore of default information in another digital multi-function peripheral. It is unnecessary for the service man to carry the portable computer and the serial cable for the maintenance service work such as default setting, or to borrow the network environment on the user side. Besides, in the default setting, the substantial influence of the communication speed between the portable computer and the digital multi-function peripheral can be eliminated. Further, there is no fear that the default information to be concealed, such as the address book, is leaked.

Further, since the backup and the restore can be performed on all default information except default information unsuitable for the object resource (model or part) of the default setting, the detailed items of the default information which the service man must set can be reduced. Accordingly, irrespective of the object resource of the default setting, the maintenance service work can be facilitated. As a result, a time required for the maintenance service work can be shortened.

Further, since the backup-restore control program is stored in the USB memory module 20 detachable from the multi-function peripheral unit, the case where the content of the maintenance service work is changed can also be easily dealt with. In the case where the backup-restore control program is stored in the multi-function peripheral unit 10, it becomes necessary to design the multi-function peripheral unit 10 in accordance with specifications including the rewriting function of the control program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital multi-function peripheral comprising:
a multi-function peripheral unit having a plurality of functions; and
a memory module detachably connected to the multi-function peripheral unit, wherein
the memory module stores a control program for backup and restore to be executed by the multi-function peripheral unit in a state where the memory module is connected to the multi-function peripheral unit, and
the control program selects various default information set in the multi-function peripheral unit as a combination information group suitable for an object resource of default setting and causes the multi-function peripheral unit to perform a backup to the memory module and a restore from the memory module.

2. The digital multi-function peripheral according to claim 1, wherein the object resource of the default setting is at least one of a model of the multi-function peripheral and a part.

3. The digital multi-function peripheral according to claim 2, wherein the multi-function peripheral unit includes an operation panel to specify default information to be backed up or restored, and the control program is structured to cause the default information specified by the operation panel to be selected as the information group.

4. The digital multi-function peripheral according to claim 3, wherein the control program is structured to exclude an unsuitable detailed item from the information group based on an error detected in the backup and the restore.

5. The digital multi-function peripheral according to claim 4, wherein the error is at least one of a result of detection of a difference between models of multi-function peripherals and a result of detection of a difference between versions of control programs.

6. The digital multi-function peripheral according to claim 4, wherein the operation panel is structured to display the error, and the control program is structured to cause determination of continuation of the backup or the restore to be performed based on an operation of the operation panel to the error.

7. The digital multi-function peripheral according to claim 1, wherein the multi-function peripheral unit encodes the default information for the backup by control of the control program, and decodes the encoded and backed up default information for restore.

8. The digital multi-function peripheral according to claim 3, wherein the control program is structured to request password input from the operation panel in advance, to store the password inputted in response to the request, together with the default information, into the memory module at the backup, and to check a password inputted in response to this request with the password stored in the memory module at the restore.

9. The digital multi-function peripheral according to claim 1, wherein the various default information is user data created by an end user of the multi-function peripheral, setting data to specify at least a function option of the multi-function peripheral, and SRAM data to define a setup environment including a hardware configuration of the digital multi-function peripheral and a basic parameter.

10. The digital multi-function peripheral according to claim 1, wherein the memory module is a USB memory module.

11. A control method for a digital multi-function peripheral including a multi-function peripheral unit having a plurality of functions, and a memory module detachably connected to the multi-function peripheral unit, comprising:
storing a control program for backup and restore into the memory module;
selecting various default information set in the multi-function peripheral unit as a combination information group suitable for an object resource of default setting by causing the multi-function peripheral unit to perform the control program in a state where the memory module is connected to the multi-function peripheral unit; and
causing the multi-function peripheral unit to perform a backup to the memory module and a restore from the memory module.

12. The control method according to claim 11, wherein the object resource of the default setting is at least one of a model of the multi-function peripheral and a part.

13. The control method according to claim 12, wherein the multi-function peripheral unit includes an operation panel to specify default information to be backed up or restored, and the default information specified by the operation panel is selected as the information group.

14. The control method according to claim 13, wherein an unsuitable detailed item is excluded from the information group based on an error detected in the backup and the restore.

15. The control method according to claim 14, wherein the error is at least one of a result of detection of a difference between models of multi-function peripherals and a result of detection of a difference between versions of control programs.

16. The control method according to claim 14, wherein the operation panel is structured to display the error, and determination of continuation of the backup or the restore is performed based on an operation of the operation panel to the error.

17. The control method according to claim 11, wherein the default information is encoded for the backup, and the encoded and backed up default information is decoded for the restore.

18. The control method according to claim 13, wherein password input is requested from the operation panel in advance, a password inputted in response to the request, together with the default information, is stored into the memory module at the backup, and a password inputted in response to this request is checked with the password stored in the memory module at the restore.

19. The control method according to claim 11, wherein the various default information is user data created by an end user of the multi-function peripheral, setting data to specify at least a function option of the multi-function peripheral, and SRAM data to define a setup environment including a hardware configuration of the digital multi-function peripheral and a basic parameter.

20. The control method according to claim 11, wherein the memory module is a USB memory module.
